(19) United States
(12) Patent Application Publication
(10) Pub. No.: US 2008/0235567 A1
(43) Pub. Date: Sep. 25, 2008

(54) INTELLIGENT FORM FILLER

(76) Inventors: BINU RAJ, Bangalore (IN); Amit Jaiswal, Bangalore (IN); Shivakumar Ganesan, Bangalore (IN); Bangalore Subbaramaiah Prabhakar, Bangalore (IN); Yarram V. Sunil Kumar, Sunnyvale, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/762,618

(22) Filed: Jun. 13, 2007

(30) Foreign Application Priority Data
Mar. 22, 2007 (IN) 630/DEL/2007

(51) Int. Cl. G06F 17/00; G06F 15/00

(52) U.S. Cl. 715/226

(57) ABSTRACT

Automatically determining values for fields in an electronic document. In one embodiment, an intelligent form filler automatically fills in at least some of the fields based on as set of rules associated with a domain. A particular set of domain rules may have class definitions that define how to classify a field for that domain and group definitions that define how to group fields. The domain rules also describe how values can be determined for the fields, based on the classifications, groupings, and other factors. In one embodiment, the intelligent form filler submits more than one form such that different combinations of values are submitted. The values that were used to fill in the form(s) may be provided to an extraction tool, which use the values to facilitate extraction of information from a document returned in response to submitting the form.

### CROSS REFERENCE TO RELATED APPLICATIONS

This application is related to and claims the benefit of priority from Indian Patent Application No. 630/DEL/2007 filed by Jaiswal et al. in India on Mar. 22, 2007, entitled “Intelligent Form Filler”; the entire content of which is incorporated by this reference for all purposes as if fully disclosed herein.

This application is related to U.S. patent application Ser. No. 11/064,278, entitled TECHNIQUES FOR CRAWLING DYNAMIC WEB CONTENT, filed by Prabhakar et al. on Feb. 22, 2005, the entire content of which is incorporated by this reference for all purposes as if fully disclosed herein.

This application is related to U.S. patent application Ser. No. 11/702,848, entitled AUTOMATIC ONLINE FORM FILLING USING SEMANTIC INFERENCE, filed by Goyal et al. on Feb. 5, 2007, the entire content of which is incorporated by this reference for all purposes as if fully disclosed herein.

### FIELD OF THE INVENTION

The present invention relates to automatic electronic form-filling. In particular, embodiments of the present invention relate to automatically filling in an electronic form based on rules for a domain.

### BACKGROUND OF THE INVENTION

### World Wide Web-General

The Internet is a worldwide system of computer networks and is a public, self-sustaining facility that is accessible to tens of millions of people worldwide. The most widely used part of the Internet is the World Wide Web, often abbreviated “WWW” or simply referred to as just “the web.” The web is an Internet service that organizes information through the use of hypermedia. The HyperText Markup Language (“HTML”) is typically used to specify the contents and format of a hypermedia document (e.g., a web page).

In this context, an HTML file is a file that contains the source code for a particular web page. A web page is the image or collection of images that is displayed to a user when a particular HTML file is rendered by a browser application program. Unless specifically stated, an electronic or web document may refer to either the source code for a particular web page or the web page itself. Each page can contain embedded references to images, audio, video or other web documents. The most common type of reference used to identify and locate resources on the Internet is the Uniform Resource Locator, or URL. In the context of the web, a user, using a web browser, browses for information by following references that are embedded in each of the documents. The HyperText Transfer Protocol (“HTTP”) is a protocol used to access a web document and the references that are based on HTTP are referred to as hyperlinks (formerly, “hypertext links”). Other protocols can also be used to obtain documents on the web. For example, a document can be obtained using a standard file transfer protocol or using some other application for file transfer. Particular protocol examples include, but are not limited to, http, https, ftp, sftp, file, etc.

Static web content generally refers to web content that is fixed and not capable of action or change. A web site that is static can only supply information that is written into the HTML source code and this information will not change unless the change is written into the source code. When a web browser requests the specific static web page, a server returns the page to the browser and the user only gets whatever information is contained in the HTML code. In contrast, a dynamic web page contains dynamically-generated content that is returned by a server based on a user's request, such as information that is stored in a database associated with the server. The user can request that information be retrieved from a database based on user input parameters.

The most common mechanisms for providing input for a dynamic web page in order to retrieve dynamic web content are HTML forms and Java Script links. HTML forms are described in Section 17 (entitled “Forms”) of the W3C Recommendation entitled “HTML 4.01 Specification,” available from the W3C® organization; the content of which is incorporated by this reference in its entirety for all purposes as if fully disclosed herein.

### Search Engines

Through the use of the web, individuals have access to millions of pages of information. However a significant drawback with using the web is that because there is so little organization to the web, at times it can be extremely difficult for users to locate the particular pages that contain the information that is of interest to them. To address this problem, a mechanism known as a “search engine” has been developed to index a large number of web pages and to provide an interface that can be used to search the indexed information by entering certain words or phases to be queried. These search terms are often referred to as “keywords.”

Indexes used by search engines are conceptually similar to the normal indexes that are typically found at the end of a book, in that both kinds of indexes comprise an ordered list of information accompanied with the location of the information. An “index word set” of a document is the set of words that are mapped to the document, in an index. For example, an index word set of a web page is the set of words that are mapped to the web page, in an index. For documents that are not indexed, the index word set is empty.

Although there are many popular Internet search engines, they are generally constructed using the same three common parts. First, each search engine has at least one, but typically more, “web crawlers” (also referred to as “crawler”, “spider”, “robot”) that “crawls” across the Internet in a methodical and automated manner to locate web documents around the world. Upon locating a document, the crawler stores the document's URL, and follows any hyperlinks associated with the document to locate other web documents. Second, each search engine contains an indexing mechanism that indexes certain information about the documents that were located by the crawler. In general, index information is generated based on the contents of the HTML file associated with the document. The indexing mechanism stores the index information in large databases that can typically hold an enormous amount of information. Third, each search engine provides a search tool that allows users, through a user interface, to search the databases in order to locate specific documents, and their location on the web (e.g., a URL), that contain information that is of interest to them.

The search engine interface allows users to specify their search criteria (e.g., keywords) and, after performing a search, an interface for displaying the search results. Typically, the search engine orders the search results prior to presenting the search results interface to the user. The order usually takes the form of a “ranking,” where the document with the highest ranking is the document considered most likely to satisfy the interest reflected in the search criteria specified by the user. Once the matching documents have been determined, and the display order of those documents has been determined, the search engine sends to the user that issued the search a “search results page” that presents information about the matching documents in the selected display order.

### Web Crawlers

There are many web crawlers that crawl and store content from the web. The web is becoming more dynamic by the day, and a larger share of the content is only accessible from behind Flash (a vector-graphic animation technology), HTML forms, JavaScript links, etc. However, it is difficult for a crawler to get past HTML forms, which are meant primarily for real users, and JavaScript content, which are written with browsers in mind, in order to access the dynamic web content behind the HTML forms and Java Scripts.

For domain-specific crawlers (also referred to as “vertical crawlers”) to access dynamic content, the crawlers typically must have some mechanism to fill out forms and follow JavaScript links. For instance, in the jobs domain, most job postings are requested by submitting HTML forms. Possible approaches to identifying and submitting forms, for vertically crawling a given web site, include manual approaches, in which a human supplies the information for the crawler to use to fill in the forms used by the web site. The human examines each web site that requires form-filling, and provides information in a script or configuration file, instructing the crawler how to fill each form on the site. Manual approaches are labor intensive and not easily scalable.

Therefore, improved techniques are desired for filling in forms using a valid combination of values. Further, improved techniques are desired for a web crawler to fill in forms in such a way that results in desired content being delivered to the web crawler.

Any approaches that may be described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a system for automatically completing an online form, according to an embodiment of the invention;

FIG. 2 is a flow diagram that illustrates a method for automatically filling an online form, according to an embodiment of the invention;

FIG. 3 is a flowchart illustrating a process of loading different rule sets, in accordance with an embodiment; and

FIG. 4 is a block diagram that illustrates a computer system upon which an embodiment of the invention may be implemented.

### DETAILED DESCRIPTION OF EMBODIMENTS OF THE INVENTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Overview

A mechanism for automatically determining values for fields in an electronic document is disclosed herein. In one embodiment, an intelligent form filler (IFF) automatically fills in at least some of the fields based on as set of rules associated with a domain (“domain rules”). As used herein, the term “domain” pertains to a realm or area. Examples of factors that can be used to define a domain include, but are not limited to, an application, a vertical, a web site, a URL, and a user identifier. A vertical refers to a category of web sites. Examples of verticals include shopping, travel, jobs, etc. A domain may be defined at the level of granularity of a web site, but could be more general. Thus, different job web sites may be, though are not required to be, in different domains. For example, different domains could be a shopping web site, a travel web site, a job web site, job web sites in general, etc. Thus, the domain rules allow for, but do not require, a level of granularity at the web site level. The rules for a particular domain may include general rules that are applicable to other verticals, as well.

A particular set of domain rules may have class definitions that define how to classify a field for that domain. For example, a field could be classified as “login,” “name,” “city,” “state,” “password,” etc. The domain rules may also have group definitions that define how to group two or more fields. For example, fields could be grouped based on some semantic relationship or dependency. As a particular example, fields that specify a lower salary and upper salary could be grouped together.

The domain rules also describe how values can be determined for the fields, based on the classifications, groupings, and other factors. In one embodiment, the IFF groups fields based on some commonality of the fields, such as location in the electronic document or properties in the HTML (or other language) that defines the electronic document. Among the other factors are the type of field (e.g., text box, drop down box, radio button, etc.).

The IFF may also determine which fields or forms in the electronic document should be filled. For example, the IFF may select for filling one form out of multiple forms in the electronic document. Also, the IFF may select which fields in a particular form should be filled. These determinations may be made based on the domain specific rules.

In one embodiment, the IFF submits more than one form such that different combinations of values are submitted. In one embodiment, the IFF validates the different combination of values that it determined for the fields. The validation stage can help to reduce the number of forms that are submitted by limiting the combinations.

The IFF can be used as part of a web crawling process, although this is not required. In one embodiment, the electronic document is submitted to a website after it is filled out. In response thereto, the website returns an electronic document. The IFF provides the values that were used to fill in the forms to an extraction tool, which is used in a web crawling process. The extraction tool looks for and extracts information such as keywords from the returned electronic document. Thus, the extraction process is facilitated by knowing what values were used to obtain the returned document.

The IFF can be used as part of an automatic form filler. For example, a user may submit a form to the IFF for automatic filling. The domain rules in this case might be based on a set of rules for automatically filling forms and a set of rules for the particular user.

### Architectural Overview of Embodiments

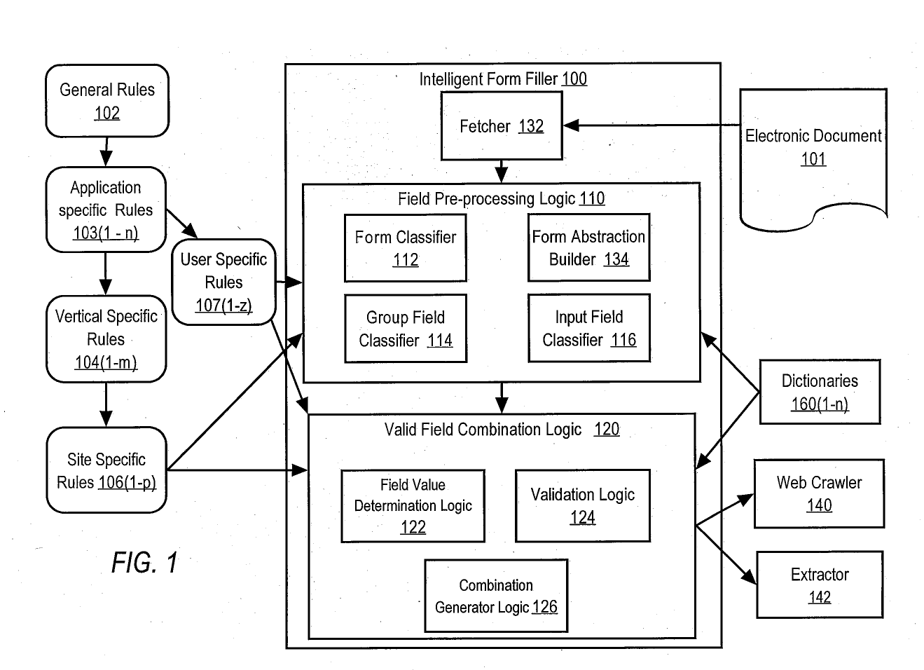

FIG. 1 is an architectural overview of an intelligent form filler (IFF) 100, in accordance with an embodiment of the present invention. In general, the IFF includes an electronic document fetcher 132, electronic document field pre-processing logic 110, and valid field combination logic 120. The IFF 100 inputs general rules 102, vertical specific rules 104(1)-104(m), site specific rules 106(1)-106(p), and dictionaries 160(1)-160(n). The IFF 100 outputs filled in forms and may provide values that were used to fill in the forms to components such as a web crawler 140 and an extractor 142.

Briefly, the fetcher 132 accesses an electronic document 101 (e.g., a web page) and passes it to the field pre-processing logic 110, which determines which forms in the document 101 to fill and pre-processes the fields. The fetcher 132 can obtain the electronic document 101 in a variety of ways. In one embodiment, the IFF 100 acts as a backend engine or a service which takes a form filling request from the user and fills the form with appropriate values. For example, if the IFF 100 is being used to automatically fill in a form that has already been loaded at a client device, then the client device may provide the electronic document 101 to the fetcher 132. As another example, the fetcher 132 obtains the electronic document 101 based on a URL and/or parameters such as cookies or post parameters. When filled-in forms are sent to the web crawler 140, other parameters such as updated cookies may be sent as well. Pre-processing the fields includes classifying fields and grouping fields.

The valid field combination logic 120 determines valid combinations of values to use to fill in the fields in the form. The valid field combination logic 120 determines more than one combination of values, in one embodiment. For example, forms with different combinations of values can be submitted to a web crawler. In another embodiment, the valid field combination logic 120 determines a single set of values. For example, the intelligent form filler can be used to help a user automatically, or semi-automatically, fill in a form.

### Rules

The rules 102, 103, 104, 106, 107 contain rules that are used to automatically determine values for fields. The general rules 102 may be applicable to all domains. Thus, the general rules 102 may be suitable for processing forms without having any knowledge of the domain. An example of a general rule is a rule that if a pull down menu contains a “Select All” value, along with other values, then “Select All” should be chosen to fill the field. The basis for this general rule may be that “select all” will return the greatest number of responses. However, if returning the greatest number of responses is not desired, then another rule may be applied.

The application specific rules 103(1-n) contain rules sets that are specific to a particular application. As an example, there may be a rule set that is for web crawling and another rule set for profile filling. The profiling filing might be used to help a user automatically, or semi-automatically, fill in a form.

The vertical specific rules 104(1)-104(m) contain a rule set for each of multiple different verticals. Thus, different vertical specific rules 104(1)-104(m) apply to different verticals, such as jobs, shopping, and travel. The verticals can have a further level of granularity, such as geographic region. For example, there may be separate verticals for United States jobs, and United Kingdom jobs. The vertical specific rules 104 override the general rules 102 if there are conflicting rules. For example, it might not be desirable to return the greatest number of responses for a given vertical. Also, a case might exists in which “select all” might not be expected to return the greatest number of responses.

The rules for a particular vertical may not be the best for a particular web site. The site specific rules 106(1)-106(p) contain rules for a particular web site. The website specific rules 106(1)-106(p) override the vertical specific rules 104(1)-104(m) and the general rules 102 if there is a conflict, in one embodiment. A given set of site specific rules can have rules that apply to an entire web site or any portion of a web site. For example, there may be rules that pertain to a particular URL.

The user specific rules 107(1)-107(z) apply to rules for a particular user. As an example, the user specific rules 107(1)-107(z) might be used to help a user automatically, or semi-automatically, fill in a form.

As used herein, the term “domain rule set” refers to the set of rules selected from the general rule set 102, the application specific rule sets 103(1)-103(n), the vertical specific rule sets 104(1)-104(m), and site specific rule sets 106(1)-106(p), the user specific rule sets 107(1)-107(z), and possibly other rule sets not depicted in FIG. 1. It is not required that rules are selected from a particular level (general 102, application specific 103, vertical specific 104, site specific 106, user specific 107). For example, rules might be selected from the general rules 102 and the vertical specific rules 104, but not any of the other rule sets.

In one embodiment, a hierarchy is followed when selecting rule sets, but this is not a requirement. An example of following a hierarchy is to select rules down the path from general 102, to application specific 103, to vertical specific 104, to site specific 106. Another example of following a hierarchy is to select rules down the path from general 102, to application specific 103, to user specific 107. The hierarchies depicted in FIG. 1 are for purposes of illustration. An example of a different hierarchy would be to use site specific rules 106 along with user specific rules 107 when doing automatic form filling. Many other hierarchies could be used.

When a vertical specific rule set 104 is used, typically the rules are selected from a single vertical specific rule set 104. However, in some cases two or more vertical specific rule sets 104 could be used. For example, if the vertical specific rule sets 104(1)-104(m) are defined at a level of granularity such that multiple rule sets exist for a job vertical, then two or more of the job vertical rules sets 104 could be used. In other words, rules might be selected from vertical specific rule set 104(1) and 104(2). When a site specific rule 106 set is used, typically the rules are selected from a single site specific rule set 106. However, in some cases two sets could be used. For example, there might be multiple rule sets for a web site or sites for a particular company. In such a case, more than one site specific rule set might be used.

### Loading Different Rule Sets

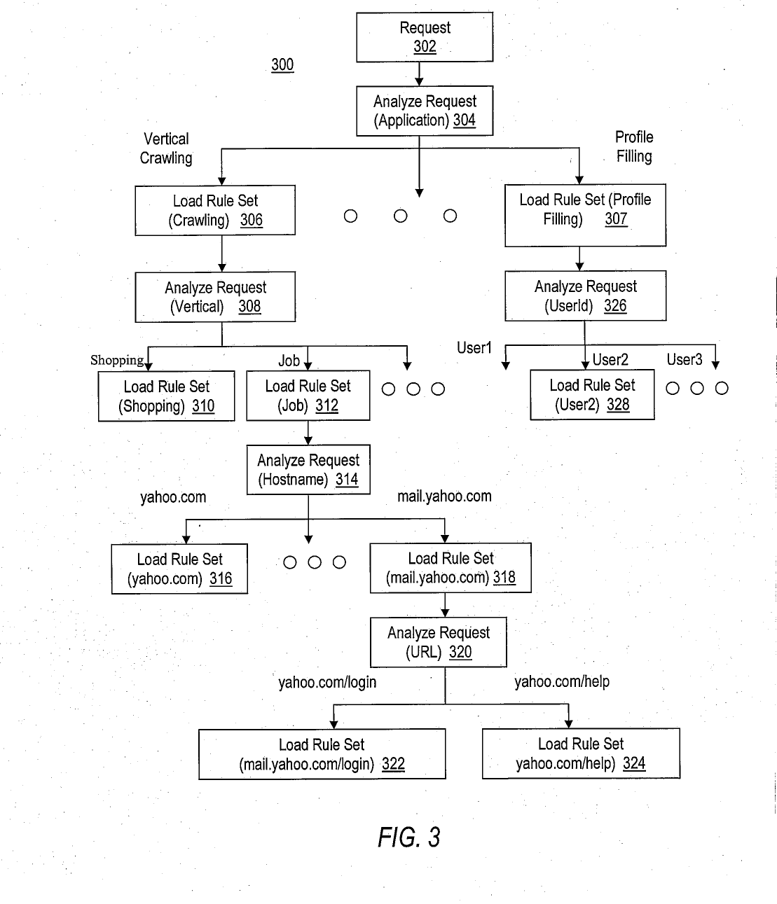

FIG. 3 describes a flowchart of a process 300 for choosing from among different rule set(s) based on the type of form filling request. Based on an analysis (step 304) of the request 302, one of a number of different paths are taken. In this example, each path is for a different application (e.g., web crawling, profile form, etc.). When entering each path, an initial set of rules (e.g., crawling 306, profile filing 307, etc.) are loaded. Then, further analysis of the request 302 is performed to determine whether to load additional rule sets. It is not required that a rule set be loaded at any particular level of the process 300.

The following examples will be used to illustrate. A request 302 arrives for filling a form for Vertical Crawling and for Ticket Vertical. Based on the application “Vertical Crawling”, the rule set “Crawling” is selected (step 306). Then, in step 308 the request 302 is analyzed based on the Ticket Vertical. In this example, there are no set of rules defined for tickets vertical. Therefore, IFF 100 does the processing using only Rule Set(Crawling).

In a second example, the request 302 is to do Job Vertical Crawling and the URL references yahoo.com. Again, based on the application the Rule Set(Crawling) is selected, in step 306. In this case, based on the vertical, the rule Set Vertical=Job is loaded, in step 312. Further, based on analysis of the hostname of the request 302 in step 314, the Rule Set Hostname=yahoo.com is loaded, in step 316. There could also be a URL specific rule set available for the given URL.

The Analyze Request steps in process 300 analyze the request 302 and decide which set of rule set to load. The specific parameters can be present in the request itself, or can be determined using some logic. For example, if the request 302 is form filling of pertaining to “mail.yahoo.com/login” for Job Vertical Crawling, then the application and vertical parameters in this case can be specified in the request 302 itself, whereas the hostname and URL are determined from the given URL. Therefore, analyzing the request 302 can be based on the parameters specified in the request 302. Alternatively, the parameters are determined by, for example, analyzing the structure of URL.

### Field Pre-Processing Logic

The field pre-processing logic 110 contains a form abstraction builder 134, form classifier 112, an input field classifier 116, and a group field classifier 114.

### Form Classifier

An electronic document 101 can have multiple forms. The form classifier 112 classifies the forms and determines which form or forms should be filled out. For example, an electronic document 101 might contain three different forms: a job search form, a resume submission form, and a feedback form. If the domain is “job search,” then the rule could be to select the job search form for filling out and submitting, while ignoring the other forms. Ignoring the other forms reduces the amount of data that the website will return and hence can improve web crawling.

As mentioned, when crawling the web, a web crawler follows hyperlinks (referred to hereafter simply as “links”) from web page to web page in order to index the content of each page. As part of the crawling process, crawlers typically parse the HTML document underlying each page, and build a DOM (Document Object Model) that represents the objects in the page. A DOM defines what attributes are associated with each object, and how the objects and attributes can be manipulated.

Generally, the IFF 100 is capable of detecting electronic documents 101 that contain forms that requires insertion of information to request content. The content may be dynamically generated by the web site (e.g., the web site accesses content from a database), or static (e.g., the web site returns web pages that satisfy criteria mentioned in the form submission. For example, such electronic documents 101 may have an HTML form through which information is submitted to a backend database in order to request content from the database. In the domain of job service electronic documents 101, for example, the form may provide for submission of information to identify the type of jobs (e.g., engineering, legal, human resources, accounting, etc.) that a user is interested in viewing, and the location of such jobs (e.g., city, state, country). The form filler is not restricted to HTML pages. Any document that has form which can be converted to HTML can be processed. In one embodiment, the IFF converts a form originally in a language other than HTML to HTML.

In one embodiment, the IFF 100 detects the presence of a form in an electronic document 101 from analysis of the corresponding DOM. For example, the form classifier 112 detects a <FORM> tag in the HTML code as represented in the DOM. The term “form” is used hereafter in reference to any type of information submission mechanism contained within code for an electronic document 101, for facilitating submission of requests to a server for dynamic web content. An HTML form is one example of an information submission mechanism that is currently commonly used. However, embodiments of the invention are not limited to use in the context of HTML and HTML forms. Hence, the broad techniques described herein can be readily adapted by one skilled in the art to work in the context of other languages in which pages are coded, such as variations of HTML, XML, and the like, and to work in the context of other electronic form mechanisms other than those specified by the <FORM> tag, including such mechanisms not yet known or developed.

In one embodiment, a form is identified based on analysis of terms in the document 101. In one embodiment, form classifier 112 analyzes information associated with the electronic document 101 (e.g., metadata) and compares such information with a dictionary 106 containing domain-specific terms, in an attempt to classify the form to a particular domain. In one embodiment, form classifier 112 examines one or more of the following, from the DOM: (a) the name of the form, (b) the name of fields in the form, (c) objects and attributes near the “submit” button, (d) anchor text, and the like. For example, if form classifier 112 identifies fields within the form that are named “model” and “make”, then form classifier 112 may determine that the form is in the automobile services domain by referencing a mapping of terms to domains from the dictionary 106.

As another example the form classifier 112 may apply a rule in which the second form is to be filled, whereas other forms are to be ignored. Such a rule might be developed based on knowledge that is peculiar to the website from which the electronic document 101 was obtained. As another example, normally in a page there will not be more than one login form or more than one job search forms. Therefore, if the form classifier 112 has already identified a job search form in a particular document 101, then other forms are not likely to a job form.

### Form Abstraction Builder

The form abstraction builder 134 groups different fields together based on one or more common properties of the fields. In one embodiment, these grouped fields are treated as a single field. In one embodiment, the form abstraction builder 134 analyzes HTML. HTML is described in “HTML 4.01 Specification, W3C Recommendation 24 Dec. 1999” (the “HTML specification”) available from the W3C organization, the content of which is incorporated by reference in its entirety for all purposes as if fully disclosed herein. The HTML specification defines the following control types: buttons, checkboxes, radio buttons, menus, text input, file select, image, password, object, embed, text area, and fieldset,. However, embodiments of the invention may be used to automatically complete types of controls other than those described in the HTML specification and to automatically complete forms other than forms constructed in HTML. For example, XHTML™ 1.0 is described in “The Extensible HyperText Markup Language (Second Edition), A Reformulation of HTML 4 in XML 1.0,” W3C Recommendation 26 Jan. 2000, revised 1 Aug. 2002, the content of which is incorporated by reference in its entirety for all purposes as if fully disclosed herein.

In one embodiment, the form abstraction builder 134 groups check boxes together. For example, if there are ten check boxes on a form, three could be placed into one group and seven into another group. As a particular example, if some check boxes are next to city names and other check boxes are next to salary ranges, the city check boxes may be placed into one group and the salary range check boxes into another group. In the embodiment in which the boxes in a group are treated as a single field, only one of the boxes needs to be checked when determining values for the form. Note that while check boxes may be logically related to each other, they are syntactically separate entities in HTML. By grouping check boxes that are related to each other they can be considered as a drop down list in which multiple values can be selected.

Note that it is not necessary at this point to determine that one group is for cities and another is for salaries. Rather, the purpose is to place related fields into a group. In this case, the textual content and location of the city names indicate some commonality.

In one embodiment, the commonalities are based on information in the HTML, or other language, that describes the form. The commonalities might be based on some explicit information such as the text that forms attributes and tags.

As examples, fields having numeric content or a common character (e.g., “$”) are examples of possible commonalities of salary check boxes. Other examples of properties that can be examined for commonalities include font color, size, type, etc. Note that other fields can be grouped in this manner, not just check boxes.

Alternatively, or in addition to the explicit information, the commonalities could be based on an implicit property in the HTML. An example of an implicit property in the HTML is the location at which the check box would be displayed if the document 101 were to be rendered (e.g., its two-dimensional visual coordinates.) That is, the HTML may not explicitly state the physical location at which check boxes are to be displayed. However, the location, at least relative to other check boxes, can be determined by analyzing rendering parameters such as font size, etc. Another example of implicit information is the presence of other HTML data between different check boxes.

### Input Field Classifier

The input field classifier 116 is able to assign a class to a field. Some examples of classes for fields are City, State, Job Type, Country, Login Name, Date, etc. As previously discussed, the rule set for a domain may contain a set of class definitions. These class definitions could be in the general rules 102, the application specific rules 103, the vertical specific rules 104, the site specific rules 106, or the user specific rules 107. In one embodiment, the class definition is based, at least in part, on a dictionary 160 match. The terms associated with a field are compared with terms in one or more of the dictionaries 160(1)-160(n) to determine to which class the field should be assigned. For example, if the input field contained terms such as California, Delaware, or Wyoming, then the input field is classified as a state field based on matches with a “state dictionary.” The rule set defines which dictionaries 106(1)-106(n) are selected for use.

The input field classifier 116 may classify fields based on other factors such as location of the field in the document 101. For example, suppose that the input field classifier 116 finds a field that has numeric values and a “$” sign. If the vertical is “jobs,” then the rules define this to be a salary field. Next, if the input field classifier 116 finds a second salary field to the right of the first, the job vertical rules define that the first salary is a minimum salary and the second is a maximum salary. These fields might be classified differently for a different vertical. As another example, a domain rule might specify that there can be only one field of a given class. For example, a rule could specify that there can be only one “login field.”

The determination of class of input field may be done individually or collectively. By collectively, it is meant that all the input fields are taken together and analyzed, and the class for each input field is determined. The collective classification helps in resolving conflicts when different input fields show similar properties. Also, the order in which fields occur in a form typically follows some pattern. For example, a “password” field typically appears after the “login” field. This information is specified in the set of rules, and is used by the input field classifier 116 to do the classification. Another example is that the rules may say that there can be only one password field in a form. This will help in doing classification when multiple classes have properties similar to a “password” field. Also, in many cases, the fields which are dependent on each other are typically adjacent to each other (e.g., Min Salary/Max Salary, Start Date/End Date). The example mentioned above for salary falls in this category as the class of an input field is determined, and based on the properties of this input field, the class of the input field adjacent to it are determined.

An input field may not have any properties of its own. For example, a form may have Min Salary and Max Salary text boxes. Further, one of the text boxes has the visual text “Salary” written to the left of it. A human will correctly interpret the two text boxes as “Min Salary” and “Max Salary” because they are of the same HTML type (text input), and aligned horizontally. For a program, the second text box has no visual text of its own, doesn't have any special words in the HTML attributes, and has no special properties of its own. But, given the fact that the input field to the left of it is of same HTML type, is aligned with it, and is of class “Salary” which can also occur in the form “Min Salary” and “Max Salary”. Hence, the properties of the adjacent input field, the similarity in the properties (same tag, visual alignment, and the fact that the “Salary” input field can also occur in pair), is used to determine the correct label. This is an example of collective classification as how the class name and properties of the adjacent input fields can be used to determine the correct class names. Finally, fields for which no specific class is identified may receive a special label of “Default” class.

### Feature Based Classification

Form classification and input field classification may be performed based on a set of features, which is some property of the input data. For example, in a dictionary match approach the set of words that appear in the form are one example of features. Other features include, but are not limited to, words that appear as visual text for input field, the words that appear in the values of input field (e.g., pull down menu, radio button, check boxes), the words that appear as text on the input field (e.g., text on button, ALT attribute value in image).

Each different set of words have some unique properties. The words which appear as visual text are usually significantly less as compared to the number of words in the pull down menus (e.g., a pull down menu for “country” may have hundred values). Visual text words though small in number, are very strong words in the sense that they give clear indication about the type of form. For example, a visual text word of “Login” clearly indicates that the form is a login form.

Different types of features hold different importance. In the context of using the features, the visual text features are less costly to use as they are small in number, give results with high confidence. For example, in a dictionary match there very small number of words to match and each word has very high weight or importance. Compared to this, doing a dictionary match against the drop down values in a form is more costly as the number of words is high. Therefore, it may take a positive match with comparatively larger number of words to be sure about the confidence of the classification. For example, suppose the drop down values contain the names of all types of jobs, then just the word “Temporary” is not a clear indication as whether the form is of type Job Search or not, as the word “Temporary” is somewhat general and can appear in different types of forms. We need to find more matches with the Job Vertical dictionary to be sure that the form is of type Job Search. In case of visual text match, the visual text would be “Job Type” and it is a very good indication that the form is Job Search. The method explained in the above example is that first try with matching against a specific type of features (such as visual text words), which is less costly and provides a high confidence. If the classification cannot be done on that feature alone, then other features can be used (such as drop down values), which is more costly. Therefore, the more costly method is attempted only when the less costly one is not able to do the classification with high confidence.

Feature based approach is used for input field classifier, in one embodiment, in which the visual text is examined first. Note that is less costly and give high confidence results. Then the drop down values or other properties are examined.

### Group Determination

The group field classifier 114 groups two or more fields together. The group field classifier 114 classifies one or more fields together based on the rule set, in accordance with one embodiment. The group field classifier 114 looks for fields having some relationship with each other. In one embodiment, the relationship is that a value for one field is dependent on the value for another field. As an example, fields for salary input may be grouped together. It may be that one of the fields is a minimum salary and the other is a maximum salary. Thus, the value for one field is dependent on the value for the other. However, it is not required that the group field classifier 114 determine that one of the fields is a minimum salary and the other is a maximum salary in order to group the fields.

The following is an operational example in which the group field classifier 114 finds the maximal set of groups of input fields present in the form based on their classes. However, the group field classifier 114 is not limited to this technique. The rule set for group field classifier 114 may include of possible set of groups of input field classes. For example, the rule set might include groups of classes “city”, “state” as [A: city, state], [B: city], [C: state]. If the form consists of both “city”, then only group B will be selected when applying these rules. If the form consists of both “city”, and “state”, then group A will be selected, and “city” and “state” will be grouped together under a single group. The word maximal is used here as IFF does not choose two groups B and C. Each possible group is given priority over other, which is used to resolve conflict when there are multiple sets of groups for a given set of input fields. Other example can be various the possible sets of groups are specified in the rule set, and each possible group has a priority over other. The group field classifier 114 finds groups in a form in such a manner that higher priority groups get preference over lower priority groups.

Unlike the form abstraction builder 134, which forms groups of fields in which typically only a single value is later determined for the group, each field in a group formed by the group field classifier 114 may be assigned its own value at a later stage. For example, the group field classifier 114 might group a “city” and a “state” field together, in which case both fields may be allowed to have a value. However, the domain rules may specify that one of the fields may or should be blank.

### Field Value Determination Logic

The field value determination logic 122 is able to determine values for fields. The field value determination logic 122 bases the determination on the domain specific rules, in one embodiment) As an example, if the domain is for “job search” and the field is a pull down drop box, then the following rules might be applied to attempt to submit one or more forms that return the maximum number of results while attempting to minimize results. A primary rule could be to use a “Select All” field if available in the drop down box. However, if “select all” is not presented as an option, but different city names are available, then each city name might be used to submit multiple forms.

However, depending on the domain rules, in one embodiment), some of the cities might not be submitted. For example, if the domain is for “United States job search,” then even if there is a select all option, it might not be selected, depending on the other available options. If all of the other available options are cities in the United States, then select all might be used. However, if some of the cities are outside of the United States, then only cities in the United States are selected. Thus, it may be that submitting a single form with “select all” is appropriate for one domain, but submitting multiple forms with selected cities is more appropriate for another domain.

Note that the domain rules are adapted to the field classification. For example, in Job search domain, if there is a “city” type text input and a “state” type text input, the rules may say to fill values in the “state” type box but leave the “city” box empty. As another example, if a field has been classified as a “country” and allows submission of text, then the domain rules might specify an appropriate value such as “United States.” However, if a field that allows text submission has been classified as a “city” then the domain rules may specify a number of different cities to use in different form submissions.

### Validation Logic

The validation logic 124 determines whether the values are valid. The validation logic 124 inputs the rules to determine whether the values are valid for a particular domain. The validation logic 124 has a single field validator, in one embodiment, which determines whether the value for a particular field is valid. As an example, field value determination logic 122 may have applied a domain rule that a city text box should be left blank, if possible. However, this city text box is also determined to be part of a group by the group field classifier 114. For example, the city text box is part of a group with a state field. In this example, a value may have been determined for the state field. The validation logic 124 could apply a domain rule that specifies that a value should be provided for the city field, given that there is a value for the state field.

The validation logic 124 has a group field validator in one embodiment, which determines whether the combination of values for a group of fields is valid. As an example, if there is a group of salary fields, then the validation logic 124 might apply a rule that states that a Min Salary input field should have value less than a Max Salary input field. Thus, in this case, the validation is dependent on values of each field relative to each other.

A rule set may specify multiple ways of filling values in a field. The validation logic 124 verifies that the values comply with at least one way of filling the fields. Furthermore, the validation logic 124 may select one or more of the valid ways of filling the fields. Only the set of values that pass through both the field validator and group validator are selected for filling, in an embodiment.

### Combination Generation Logic

The combination generation logic 126 is responsible for causing different valid combinations of values to be determined. Thus, different forms with different combinations of values can be determined such that an appropriate number of different combinations of values are submitted.

For example, the form may have been divided into three groups (e.g., a geography group, a salary group, and a job type group) with multiple possible combinations of values for each group. The combination generation logic 126 determines which combinations are suitable for submission. For example, there might be ten possible valid combinations for each group, but the combination generation logic 126 determines that only two of the valid combinations for the salary group will be used. The domain rules can specify that a class of field is not as important as others, such that only one possible value for the field is used. As a particular example, the form may allow the user to specify the order in which job search results are returned (e.g., by salary, region, etc.). Because this does not alter the content, the domain rule may specify that the value for this field is not significant. Therefore, one value is selected and used in all form submissions.

Other examples are that the combination generation logic 126 might determine, based on the domain rules, that a certain job type should not be submitted in a certain geographic region, or that the salary range should be dependent on the geographic region. Many other types of rules could be used. Thus, the total number of forms that are submitted can be reduced, while still allowing for a high number of results to be returned.

Selecting values to be submitted is based an objective for form filling, in an embodiment. One objective can be to fill the form with a reduced number of combinations without a substantial drop in the content that is returned from the website site. By reducing the number of combination, the number of requests sent to the website can be reduced while still obtaining all or most of the desired content that would be obtained with a higher number of requests. Another objective can be to fix an upper limit on the number of form submissions and to determine combinations of values that are expected to increase or even maximum the amount of desired content from the website. Another objective function can be to set a maximum limit on the number of combinations that can be submitted, and determine combinations of values in which some fields are filled more often than others based on the expectation that some fields generate better feedback. As an example of this objective, suppose that “Job Title” is a difficult field to extract for the extractor. Therefore, not to find combination in which we try to iterate over “Job Title” input field with specific values for that input field.

In one embodiment, fields are assigned an importance level (based, for example on expectation of filling the field returning desired content). The combination logic has a bias in favor of filling in fields that are considered more important. For example, a rule set might impose a limit on the maximum number of form submissions that are allowed. In this case, if the number of combinations that are generated after selecting values to be filled in each group of input fields exceed this limit, then the more important fields are iterated more often than others. For example, assume there is an input field for a “Search Keyword” text input in a job search form, and there is a set of keywords for job search from the rule set. Then the Search Keyword input field is filled in first, such that all values for this field are part of the form submission.

### Executing JavaScript Functions

When filling in some fields, a Java Script function, or other scripting language function, may be executed. Java Script-based forms may require execution of one or more JavaScript functions in order to, for example, manipulate control data (e.g., search parameter values) prior to submission of the form, and/or submit the form to the host server (e.g., execute onsubmit( ) function or onclick( ) function). Further, some web sites require execution of Java Script functions that lead to a simple url/link being fetched, without a form involved. A Java Script function typically takes input from a user or from the web page, manipulates the input, and submits the resultant form data set to the server to request dynamic content.

For example, in the context of an automobile services site, a requester may type in an automobile maker, and execution of a JavaScript results in presentation of the automobile models associated with that maker. The requester may then select a presented model and submit the form, and the Java Script may encode the form data set in a server-specific format and submit the encoded data set to the server in order to complete the request for dynamic content. With the techniques described herein, the “requester” is an automated agent (e.g., Java Script link submitter that does not require actual user input.

### Process of Automatically Filling a Form in Accordance with an Embodiment

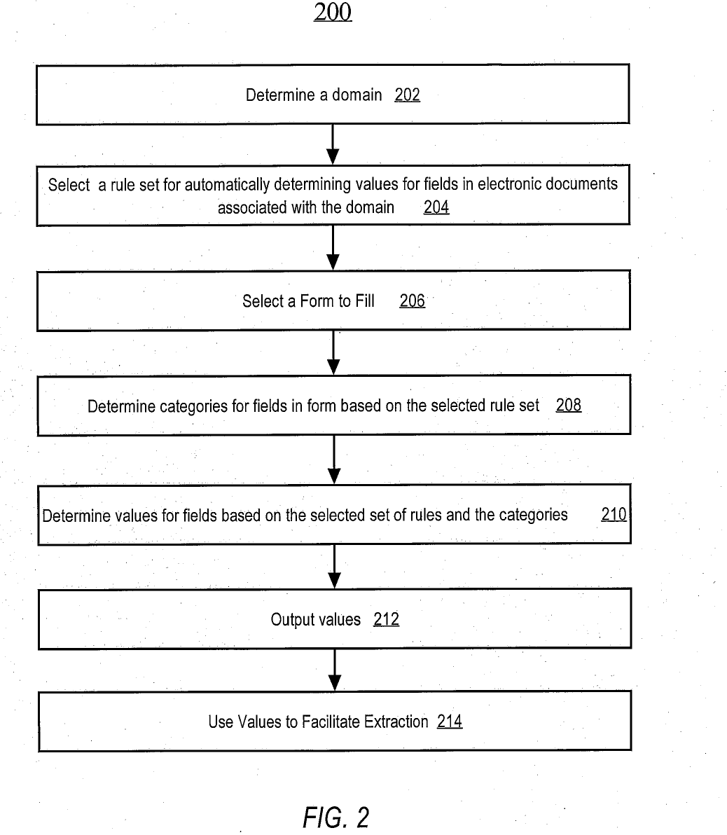

FIG. 2 is a flowchart illustrating a process 200 of automatically filling in fields in an electronic document 101 based on a rule set for a domain, in accordance with an embodiment. Process 200 will be discussed by referring to the IFF 100 of FIG. 1; however, process 200 is not so limited. While steps of process 200 are discussed in a particular order, the process 200 is not limited to being performing in this order. In step 202, the field pre-processing logic 110 determines a domain associated with an electronic document 101 that includes one or more fields for receiving values. The field pre-processing logic 110 factors in the vertical (e.g., U.S. jobs, shopping, etc.) and the web site from which the document 101 was fetched, in one embodiment. The pre-processing logic 110 may also group the checkboxes which are logically belonging to each other together.

In step 204, the field pre-processing logic 110 selects a rule set (“selected rules”) for automatically determining values for fields in electronic document 101 associated with the domain. The rule set is selected by selected rules from one or more of the general rules 102, the vertical specific rules 104(1)-104(m), and the site specific rules 106(1)-106(p), in one embodiment.

In step 206, the field pre-processing logic 110 selects one or more forms in the document 101 to be filled out (“selected form”).

In step 208, the field pre-processing logic 110 determines categories for one or more of the fields in the selected form. The field pre-processing logic 110 can categorize a field in numerous ways. For example, the field pre-processing logic 110 can use the form abstraction builder 134, the input field classifier 116, or the group field classifier 114, as previously discussed. The field pre-processing logic 110 uses the selected rules to perform at least some of the categorizing. The pre-processing logic 110 also determines the visual text associated with each label, in an embodiment. The visual text may be determined using the DOM tree of document, the visual properties, two-dimensional visual coordinates.

In step 210, the valid field combination logic 120 determines values for selected fields, based on the selected rules. Step 210 may include determining possible values and validating the possible values. In one embodiment, the valid field combination logic 120 determines different combinations of valid values. In one embodiment, the valid field combination logic 120 determines a single combination of valid values.

In step 212, the IFF 100 outputs the values. For example, the IFF 100 outputs one or more filled in forms to a web crawler 140. The IFF 100 may output, to the extractor 142, details of the fields that were selected, as well as the filled in form.

In step 214, the extractor 142 uses the values to intelligently extract keywords and the like from documents. For example, the document that is returned in response to submitting the form may have many numeric values therein. If the extractor 142 knows what salary range was submitted, the extractor 142 can use this information to facilitate the determination of which values pertain to a salary and which values do not. As another example, the returned document might have many different elements that could be a job title. If the extractor 142 knows that the value for a job type field was “accountant,” the likelihood of making an error in extracting a job title is reduced.

### Hardware Overview

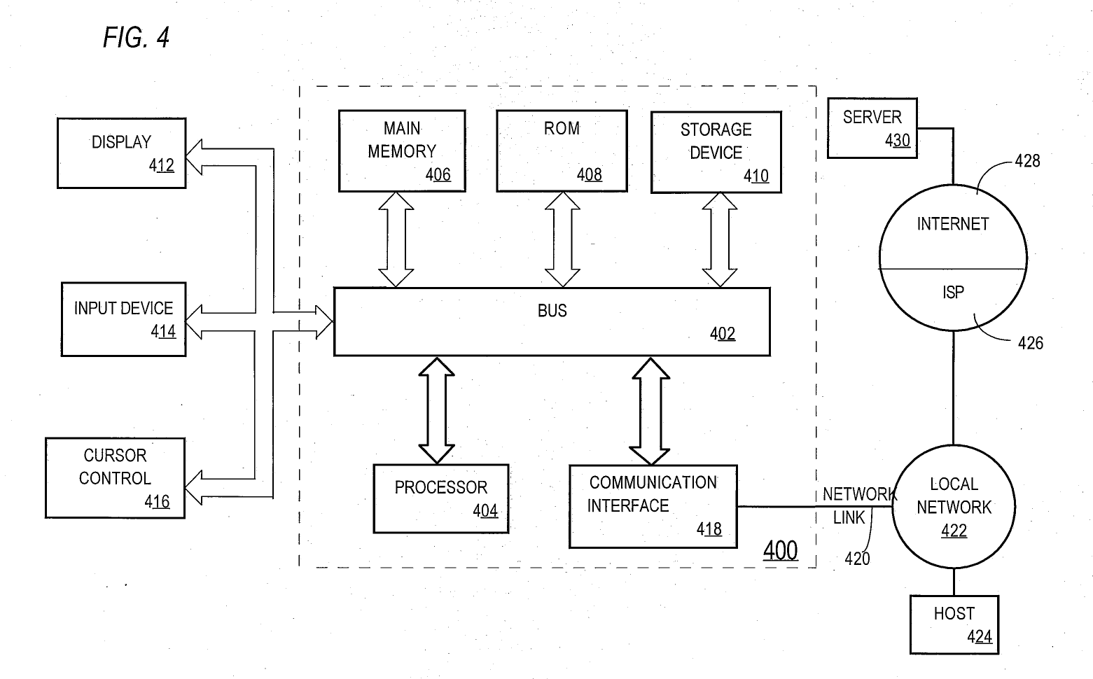

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

### Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

Alternative embodiments of the invention are described throughout the foregoing specification, and in locations that best facilitate understanding the context of the embodiments. Furthermore, the invention has been described with reference to specific embodiments thereof. It will, however, be evident that various modifications and changes may be made thereto without departing from the broader spirit and scope of the invention.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

What is claimed is:

1. A method comprising:
determining a domain associated with an electronic document that includes one or more fields for receiving values;
selecting, from a plurality of rule sets, a rule set for automatically determining values for fields in electronic documents associated with the domain;
for a field in the electronic document, determining a category based on the selected rule set; and
for the field, determining a value based on the selected set of rules and the category for the field.

2. The method of claim 1, further comprising:
for a plurality of fields in the electronic document, determining respective categories for the fields based on the selected rule set; and
for the plurality of fields, determining a plurality of combinations of values for the plurality of fields in the electronic document.

3. The method of claim 1, wherein determining the category for the field includes classifying the field based on a set of class definitions in the selected rule set.

4. The method of claim 1, wherein determining the category for the field includes grouping two or more of the fields based on the selected rule set.

5. The method of claim 1, wherein selecting the rule set is based on a selected vertical.

6. The method of claim 1, wherein selecting the rule set is based on a source associated with the electronic document.

7. The method of claim 1, wherein the electronic document is a first document, and further comprising:
using the value for the field to facilitate extracting a term from a second electronic document that is received in response to submitting the first electronic document with the field filled in with the value.

8. The method of claim 1, further comprising determining for which fields in the electronic document to determine a value, based on the selected rule set.

9. The method of claim 1, wherein the field is one of a plurality of types of fields, and wherein determining the category for the field is further based on the type of field.

10. The method of claim 1, further comprising grouping fields in the electronic document that are semantically related.

11. A method comprising:
selecting, from a plurality of rule sets, a rule set for automatically determining values for fields in electronic documents associated with a domain;
for a plurality of fields in the electronic document, determining respective categories for the fields based on the selected rule set; and
for the plurality of fields, determining a plurality of combinations of values for the plurality of fields in the electronic document based on the selected rule set.

12. The method of claim 11, further comprising selecting at least one of the plurality of combinations of values based on the selected rule set.

13. The method of claim 11, wherein determining respective categories for the fields includes classifying the field based on a set of class definitions in the selected rule set.

14. The method of claim 11, wherein determining respective categories for the fields includes grouping two or more of the fields based on the selected rule set.

15. The method of claim 11, wherein selecting the rule set is based on a selected vertical.

16. The method of claim 11, wherein selecting the rule set is based on a source associated with the electronic document.

17. The method of claim 11, wherein the electronic document is a first document, and further comprising:
submitting the first electronic document with a first of the combinations of values; and
using the first combination of values to facilitate extracting terms from a second electronic document that is received in response to submitting the first electronic document.

18. The method of claim 11, further comprising determining for which fields in the electronic document to determine a value, based on the selected rule set.

19. The method of claim 11, wherein the field is one of a plurality of types of fields, and wherein determining the category for the fields is further based on the type of field.

20. The method of claim 11, further comprising grouping fields in the electronic document whose values are dependent on one another.

21. The method of claim 11, wherein determining the plurality of combinations is based on an objective for filling in the electronic document.

22. The method of claim 21, wherein the objective is to reduce the number of said plurality of combinations without substantially reducing desired content returned in response to submitting the electronic document with each of the plurality of combinations.

23. The method of claim 11, wherein determining the plurality of combinations includes determining how frequently a field of the plurality of fields should be filled in based on an importance assigned to the field.

24. The method of claim 23, wherein the importance is based on quality of feedback that filling in the field will generate.
